(19) United States
(12) Patent Application Publication
(10) Pub. No.: US 2004/0158397 A1
(43) Pub. Date: Aug. 12, 2004

(54) Transport system and method thereof

(75) Inventor: Young-Il Cho, Seoul City (KR)

Correspondence Address: STAAS & HALSEY LLP, SUITE 700, 1201 NEW YORK AVENUE, N.W., WASHINGTON, DC, 20005, US

(73) Assignee: SAMSUNG Electronics Co., Ltd., Suwon-city (KR)

(21) Appl. No.: 10/717,652

(22) Filed: Nov. 21, 2003

(30) Foreign Application Priority Data
Feb. 10, 2003 (KR) 2003-8273

(51) Int. Cl. G01C 21/30

(52) U.S. Cl. 701/209

(57) ABSTRACT

A transport system transporting an article along a transport route includes a job assigning part receiving at least one job order, calculating a transport time to be taken when transport vehicles in the transport route perform respective job orders, and creating job assignment information to assign each job order to the transport vehicle having a minimum transport time according to each job order, the transport vehicles traveling in opposite directions of the transport route, and a route searching part receiving the job assignment information from the job assigning part, creating route search information by searching an optimum route having the minimum transport time to be taken when the transport vehicle assigned with the job order travels from a starting position to a target position along the opposite directions of the transport route, and updating the route search information by searching routes in real time when the transport vehicle travels. Thus, the job orders can be effectively assigned to the transport vehicle, and an optimum route can be searched according to various time information. Also, circumstances of the transport route can be reflected in real time, thereby increasing the transport efficiency.

### CROSS-REFERENCE TO RELATED APPLICATIONS

This application claims the benefit of Korean Patent Application No. 2003-8273, filed Feb. 10, 2003, in the Korean Intellectual Property Office, the disclosure of which is incorporated herein by reference.

### BACKGROUND OF THE INVENTION

1. Field of the Invention

The present invention relates to a transport system, and more particularly, to transport system and method of improving a job order assignment and a route search to enhance a transportation efficiency.

2. Description of the Related Art

A transport system is herein defined as a system that transports an article from a starting position, such as processing equipment or a storehouse, to a target position by using a transport vehicle traveling along a transport route provided in a production line or the like.

A conventional transport system transmits a job order including the starting position and the target position of the article, and assigns the job order to the transport vehicle nearest to the starting position in a traveling direction of the transport vehicle among available vehicles, so as to transport the article from the starting position to the target position. The conventional transport system then searches for a shortest route along which the transport vehicle assigned with the job order can travel from the starting position to the target position along the traveling direction of the transport route, and allows the transport vehicle to perform the job order along the shortest route.

The transport vehicle traveling by the conventional transport system is set to travel on the transport route in only one direction.

An example of the conventional transport system will be described hereinbelow, with reference to a layout 120 shown in FIG. 1.

As shown in FIG. 1, the layout 120 of the conventional transport system includes a plurality of equipment 123, such as processing equipment and storehouses, a transport route 121 installed to connect the equipment 123, first through eighth nodes 131-138 provided on the transport route 121 corresponding to the respective equipment 123, and a plurality of transport vehicles 125 traveling along the transport route 121.

The transport vehicle 125 transports an article from one node selected to correspond to the equipment in a starting position to another node selected to correspond to the equipment in a target position according to a job order of the conventional transport system.

With the above configuration, a process in which the conventional transport system is implemented will be described by way of example, with reference to FIG. 1.

Assuming that the job order that the starting position of the article corresponds to the fourth node 134 and the target position thereof corresponds to the eighth node 138 is given, the transport system assigns the job order to one of the transport vehicles 125 nearest to the fourth node 134 in a traveling direction of the transport vehicles 125 among the available transport vehicles 125 and searches for the shortest route along which the transport vehicle 125 assigned with the job order can travel from the fourth node 134, i.e., the starting position, to the eighth node 138, i.e., the target position, in the traveling direction after loading the article thereon in the fourth node 134. Accordingly, the job order is assigned to the transport vehicle 125 positioned in the third node 133. Based on the searched shortest route according to the job order, the transport vehicle 125 travels along the transport route, passing through a total of 10 nodes which include first 5 nodes in the shortest route along which the transport vehicle 125 positioned in the third node 133 travels from the third node 133 to the fourth node 134 (starting position) in the traveling direction thereof, i.e., sequentially passing through the second node 132, the sixth node 136, the seventh node 137, the eighth node 138, and the fourth node 134, to load the article thereon, and second 5 nodes in the shortest route along which the transport vehicle 125 loaded with the article thereon at the fourth node 134 travels from the fourth node 134 to the eighth node 138 (target position), i.e., sequentially passing through the third node 133, the second node 132, the sixth node 136, the seventh node 137, and the eighth node 138.

Accordingly, the article can be transported from the starting position to the target position by using the conventional transport system.

However, when the article is transported by using the conventional transport system, the transport vehicle travels in only one direction, and thus, the traveling route thereof is lengthened, thereby decreasing a transport efficiency.

Also, because the conventional transport system depends only on information on the traveling distance when the conventional transport system assigns the job order to the transport vehicle and searches for the traveling route of the transport vehicle, the transport efficiency is lowered.

In addition, the conventional transport system does not appropriately allow the transport route to be changed in real time according to circumstances of the transport route because the traveling route of the transport vehicle cannot be changed after the traveling route searched is transmitted to the transport vehicle.

### SUMMARY OF THE INVENTION

Accordingly, it is an aspect of the present invention to provide a transport system improving a transportation efficiency and reflecting circumstances of a transport route in real time.

Additional aspects and advantages of the invention will be set forth in part in the description which follows and, in part, will be obvious from the description, or may be learned by practice of the invention.

The foregoing and/or other aspects of the present invention are achieved by providing a transport system transporting an article along a transport route. The transport system includes a job assigning part receiving at least one job order, calculating a transport time to be taken when transport vehicles travel in opposite directions along the transport route to perform respective job orders, and creating job assignment information to assign each job order to one of the transport vehicles having a minimum transport time according to each job order, and a route searching part receiving the job assignment information from the job assigning part, creating route search information by searching an optimum route having the minimum transport time to be taken when the transport vehicle assigned with the job order travels from a starting position to a target position in the opposite directions of the transport route, and updating the route search information by searching routes in real time when the transport vehicle travels.

According to another aspect of the invention, the transport vehicle travels from the starting position to a predetermined reservation position which is reserved as a predetermined section on the traveling route between the starting position and the target position.

According to another aspect of the invention, the transport time of the transport vehicle includes a traveling time from the starting position to the target position, a working time of the transport vehicle, a section reservation time of other transport vehicles, and an occupation time of the other transport vehicles.

According to another aspect of the invention, the traveling time includes a sum of time calculated from distances between nodes from the starting position to the target position and speeds of the transport vehicle traveling between the nodes.

According to another aspect of the invention, the working time of the transport vehicle includes a first time to be taken when the transport vehicle is disposed to load and/or unload an article at the nodes, such as the starting position and the target position, a second time to be taken when the transport vehicle is charged, a third time to be taken in a case of an error, which would occur in the transport vehicle, to be solved, and a fourth time to be taken when the job order currently performed is completed.

According to another aspect of the present invention, a transport system transporting an article from a start node to a target node along a transport route having nodes including the start and target nodes includes transporting vehicles moving along the transport route in opposite directions of the transport route, a job order manager unit receiving at least one job order from an external host to move the article disposed in the start node to the target node, creating job assignment information to assign the at least one job order to a corresponding one of the transport vehicles having a minimum transport time to be taken when the one transport vehicle perform the at least one job order, and creating route search information by searching an optimum route having the minimum transport time to be taken when the one transport vehicle travels from the starting node to the target nodes in the opposite directions of the transport route, and a job order executing unit controlling the one transport vehicle according to the job assignment information and the route search information.

According to another aspect of the present invention, a transport method of transporting an article from a start node to a target node along a transport route having nodes including the start and target nodes includes moving transport vehicles along the transport route in opposite directions of the transport route, receiving at least one job order from an external host to move the article disposed in the start node to the target node, creating job assignment information to assign the at least one job order to a corresponding one of the transport vehicles having a minimum transport time to be taken when the one transport vehicle perform the at least one job order, creating route search information by searching an optimum route having the minimum transport time to be taken when the one transport vehicle travels from the starting node to the target nodes in the opposite directions of the transport route, and controlling the one transport vehicle according to the job assignment information and the route search information.

### BRIEF DESCRIPTION OF THE DRAWINGS

These and/or other objects and advantages of the invention will become apparent and more readily appreciated from the following description of the preferred embodiments taken in conjunction with the accompanying drawings in which:

FIG. 1 is a layout of a conventional transport system;

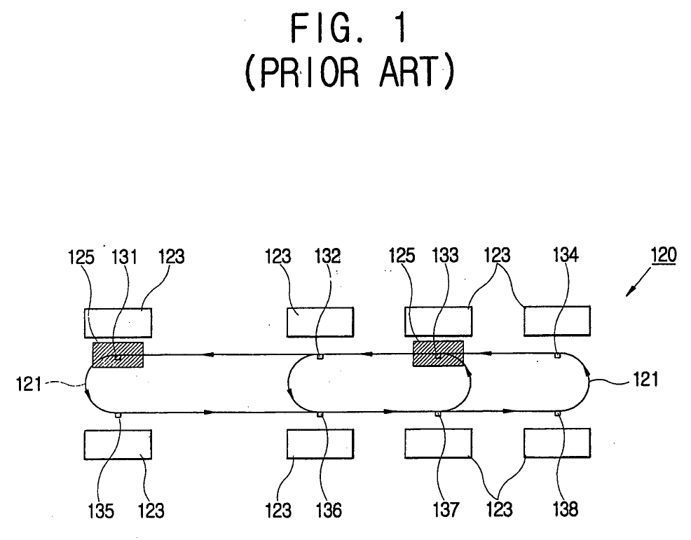

FIG. 2 is a block diagram of a transport system according to an embodiment of the present invention;

FIG. 3 is a flow diagram of the transport system shown in FIG. 2; and

FIG. 4 is a layout of the transport system shown in FIG. 2.

### DETAILED DESCRIPTION OF THE PREFERRED EMBODIMENTS

Reference will now be made in detail to the embodiment of the present invention, examples of which are illustrated in the accompanying drawings, wherein like reference numerals refer to like elements throughout. The embodiment is described below in order to explain the present invention by referring to the figures.

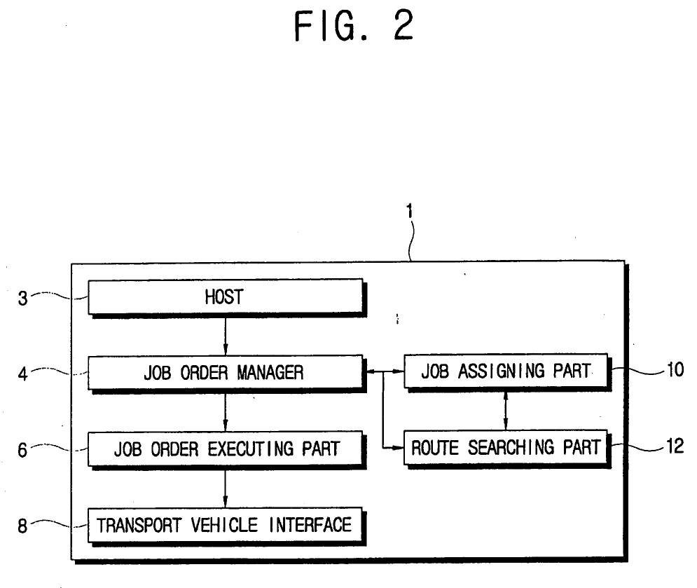

As shown in FIG. 2, a transport system 1 according to an embodiment of the present invention includes a host 3 transmitting a job order, a job order manager 4 receiving the job order transmitted from the host 3 and communicating the job order with a job assigning part 10 or the like, (to be described later) the job assigning part 10 creating job assignment information by performing a job assignment according to the job order received from the job order manager 4 and transmitting the job assignment information to the job order manager 4 and a route searching part 12, the route searching part 12 creating route search information by searching routes according to the job order received from the job order manager 4 and transmitting the route search information to the job assigning part 10 and the job order manager 4, a job order executing part 6 receiving the job assignment and/or route search information transmitted from the job order manager 4 and transmitting the job assignment and/or route search information to a transport vehicle interface 8 which allows a transport unit, such as a transport vehicle, to perform the job order by receiving the job assignment and/or route search information transmitted by the job order executing part 6.

The transport system 1 sets the transport vehicle to travel in both (forward and backward) directions of the transport route. Also, the transport system 1 makes a section reservation, which allows the transport vehicle to travel from the starting position to a predetermined reservation position between the starting position and a target position.

When one or more job orders are transmitted to the job assigning part 10, the job assigning part 10 calculates a transport time to be taken when the respective transport vehicles in the transport route perform each job order, and creates the job assignment information for assigning each job order to one of the transport vehicles having a minimum transport time according to each job order. The job assigning part 10 transmits the job assignment information to the route searching part 12 and the job order manager 4.

The route searching part 12 receives the job assignment information from the job assigning part 10, searches an optimum route having the minimum transport time to be taken when the transport vehicle assigned with the job order travels from the starting position to the target position along the opposite directions of the transport route, and then creates the route search information. Also, the route searching part 12 updates the route search information by searching routes in real time when the transport vehicle travels. The route searching part 12 then transmits the route search information to the job assigning part 10 and the job order manager 4.

The transport time of the transport vehicle in the job assigning part 10 and the route searching part 12 includes a traveling time from the starting position to the target position, a working time of the transport vehicle, a section reservation time of other transport vehicles, and an occupation time of the other transport vehicles.

Here, the traveling time includes a sum of time calculated from distances between nodes from the starting position to the target position and speeds of the transport vehicle traveling between the nodes.

The working time of the transport vehicle includes a first time to be taken when the transport vehicle is in place to load and/or unload an article at the nodes, such as the starting position and the target position, a second time to be taken when the transport vehicle is charged, a third time to be taken when an error, which would occur in the transport vehicle, is solved, a fourth time to be taken when a job order currently performed is completed, and the like.

The section reservation time of the other transport vehicles includes a delay time occurring when the transport vehicle whose transport time will be calculated, travels a reserved section reserved for the other transport vehicles having a priority to travel the nodes of the reserved section, in a case that the reserved section of the transport route is reserved for the other transport vehicles, and the transport vehicle whose transport time will be calculated has to travel the nodes of the reserved section.

The occupation time of the other transport vehicle includes time to be taken when the transport vehicle whose the transport time will be calculated is delayed by occupation of the other transport vehicles when the other transport vehicles occupy the nodes between the starting position and the target position.

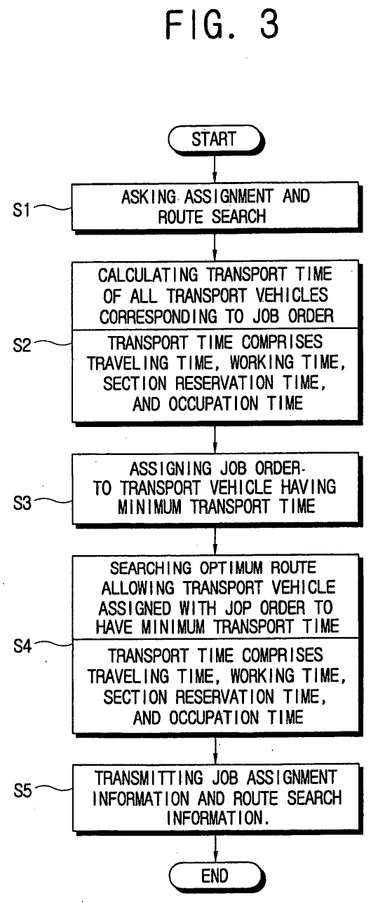

FIG. 3 is a flow chart of the job assigning part 10 and the route searching part 12 of the transport system 1 shown in FIG. 2.

A process that the job assigning part 10 and the route searching part 12 of the transport system 1 will be described as follows, with reference to FIG. 3.

At first, the job order manager 4 controls the job assigning part 10 and the route searching part 12 to perform a job assignment and a route search according to the job order in operation S1. The job assigning part 10 calculates the transport time of all the transport vehicles corresponding to the job order in operation S2. Here, the transport time of the transport vehicle is calculated so as to include the traveling time from the starting position to the target position, the working time of the transport vehicle, the section reservation time of the other transport vehicles, and the occupation time of the other transport vehicles as described above. The job order is assigned to the transport vehicle having the minimum transport time in operation S3. Searched is an optimum route allowing the transport vehicle assigned with the job order to have the minimum transport time in operation S4. Here, the transporting time of the transport vehicle by the route searching part 12 is calculated in the same way as in calculation of the transport time of the transport vehicle by the job assignment part 10. The job assignment information of the job assigning part 10 and the route search information of the route searching part 12 are transmitted to the job order manager 4 in operation S5, to thereby allowing the job order to be executed.

Thus, the transport system 1 sets the transport vehicle to travel in the opposite directions of the transport route, effectively assigns job orders to the transport vehicles by using the job assigning part 10 and the route searching part 12, and searches the optimum route by using various time information. Also, the transport system 1 can reflect circumstances of the transport route in real time, and thus the transport efficiency increases.

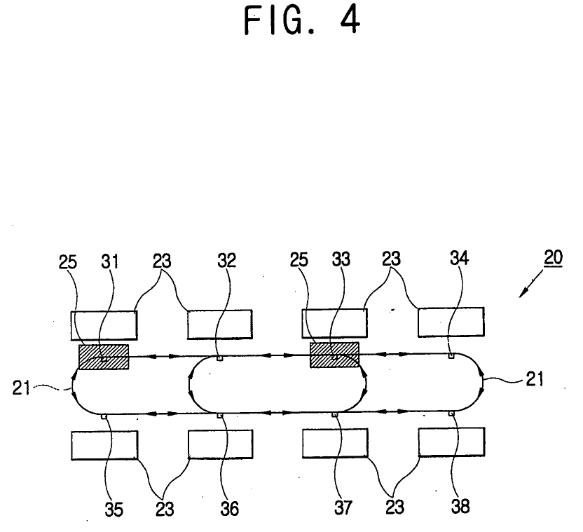

A layout 20 of the transport system 1 will be described with reference to FIG. 4.

As shown in FIG. 4, the layout 20 of the transport system 1 includes pluralities of equipment 23, such as processing equipment and storehouses, a transport route 21 installed to pass through each equipment 23, first through eighth nodes 31-38 provided on the transport route 21 corresponding to the respective equipment 23, and a plurality of transport vehicles 25 traveling along the transport route 21 in the opposite directions of the transport route 21.

Thus, the transport vehicle 25 transports the article from one node corresponding to the equipment in the starting position to another node corresponding to the equipment in the target position according to the job order of the transport system 1.

With the above configuration, a process which is implemented in the transport system 1 will be described by way of example, with reference to FIG. 4.

Assuming that the job order, that the starting position of the article corresponds to the fourth node 34 and the target position thereof corresponds to the eighth node 38, is given, the transport system 1 calculates the transport time of the respective transport vehicles 25 for the job order and assigns the job order to the transport vehicle 25 having the minimum transport time. If the transport vehicle 25 is positioned in the third node 33, the transport system 1 searches an optimum route of the transport vehicle 25 positioned in the third node 33. The optimum route of the transport vehicle 25 is searched in a way that the transport system 1 searches a route having a minimum transport time by searching all routes from the third node 33, i.e., a current position of the transport vehicle 25, to the fourth node 34 and from the fourth node 34, i.e., the starting position, to the eighth node 3, i.e., the target position. The transport time of the transport vehicle 25 is calculated as described above. The optimum route searched by the job order is described as follows. That is, the optimum route is a route along which the transport vehicle 25 travels rightward from the third node 33, i.e., a current position of the transport vehicle 25, to the fourth route 34 (starting position), loads the article thereon, and travels to the eighth node 38 (target position). Thus, the transport vehicle 25 travels through only 2 nodes.

Thus, the transport system 1 according to the present invention can considerably increase the transport efficiency, compared with a conventional transport system.

As described above, the transport system 1 according to the present invention sets the transport vehicle 25 to travel in the opposite directions of the transport route, effectively assigns the job orders to the transport vehicles using the job assigning part 10 and the route searching part 12, and searches the optimum route by using various time information. Also, the transport system 1 can reflect the circumstances of the transport route in real time, thereby increasing the transport efficiency.

As described above, according to the present invention, the job orders can be effectively assigned to the transport vehicle, and the optimum route can be searched according to various time information. Also, the circumstances of the transport route can be reflected in real time, thereby increasing the transport efficiency.

Although an embodiment of the present invention has been shown and described, it would be appreciated by those skilled in the art that changes may be made in this embodiment without departing from the principles and spirit of the invention, the scope of which is defined in the claims and their equivalents.

What is claimed is:

1. A transport system transporting an article along a transport route, comprising:
transporting vehicles moving along the transport route in opposite directions of the transport route;
a job assigning part receiving at least one job order, calculating a transport time to be taken when the transport vehicles in the transport route perform respective job orders, and creating job assignment information to assign each job order to a corresponding one of the transport vehicles having a minimum transport time according to each job order; and
a route searching part receiving the job assignment information from the job assigning part, creating route search information by searching an optimum route having the minimum transport time to be taken when the transport vehicle assigned with the job order travels from a starting position to a target position in the opposite directions of the transport route, and updating the route search information by searching routes in real time when the transport vehicle travels.

2. The transport system according to claim 1, wherein the transport route comprises a predetermined reservation position disposed between the starting position and the target position as a reserved section, and the transport vehicle travels from the starting position to the predetermined reservation position.

3. The transport system according to claim 2, wherein the transport time of the transport vehicle comprises:
a traveling time from the starting position to the target position;
a working time of the transport vehicle;
a section reservation time of other ones of the transport vehicles; and
an occupation time of the other transport vehicles.

4. The transport system according to claim 3, wherein the transport route comprises nodes, and the traveling time comprises:
a sum of time calculated from distances between the nodes from the starting position to the target position and speeds of the transport vehicle traveling between the nodes.

5. The transport system according to claim 3, wherein the transport route comprises nodes, and the working time of the transport vehicle comprises:
a first time to be taken when the transport vehicle is in place to load and/or unload the article at the nodes corresponding to the starting position and the target position;
a second time to be taken when the transport vehicle is charged;
a third time to be taken when an error, which occurs in the transport vehicle, is solved; and
a fourth time to be taken when the job order currently performed is completed.

6. The transport system according to claim 4, wherein the working time of the transport vehicle comprises:
a first time to be taken when the transport vehicle is in place to load and/or unload the article at the nodes corresponding to the starting position and the target position;
a second time to be taken when the transport vehicle is charged;
a third time to be taken when an error, which occurs in the transport vehicle, is solved; and
a fourth time to be taken when the job order currently performed is completed.

7. A transport system transporting an article from a start node to a target node along a transport route having nodes including the start and target nodes, comprising:
transporting vehicles moving along the transport route in opposite directions of the transport route;
a job order manager unit receiving at least one job order from an external host to move the article disposed in the start node to the target node, creating job assignment information to assign the at least one job order to a corresponding one of the transport vehicles having a minimum transport time to be taken when the one transport vehicle performs the at least one job order, and creating route search information by searching an optimum route having the minimum transport time to be taken when the one transport vehicle travels from the starting node to the target nodes in the opposite directions of the transport route; and
a job order executing unit controlling the one transport vehicle according to the job assignment information and the route search information.

8. The transport system according to claim 7, wherein the nodes comprise first nodes and second nodes, the transport route comprises first and second sub-routes on which the first and second nodes are disposed, respectively, and third sub-routes coupling corresponding ones of the first nodes of the first sub-route and the second nodes of the second sub-route, and the optimum route represents that the one transport vehicle disposed on one of the nodes moves from the one of the nodes to the start node using a nearest one of the third sub-routes.

9. The transport system according to claim 8, wherein the optimum route represents that the one transport vehicle moves from the start node to the target node using another nearest one of the third sub-routes disposed between the start node and the target node.

10. The transport system according to claim 8, wherein the nodes comprise a reserved section node disposed between the start node and the target node for one of the transport vehicles having a priority, and the one transport vehicle disposed on one of the nodes moves from the one of the nodes to the start node by using the reserved section node.

11. The transport system according to claim 10, wherein the minimum transport time comprises:
a time taken when the one transport vehicle is disposed in the reserved section node.

12. The transport system according to claim 10, wherein the minimum transport time comprises:
a time taken when the other one of the transport vehicles is disposed in the reserved section node when the other one of the transport vehicles has the priority.

13. The transport system according to claim 8, wherein the minimum transport time comprises:
a time taken when the other one of the transport vehicles occupies the nodes on the optimum route between the start and target nodes.

14. The transport system according to claim 8, wherein the one transport vehicle moves the first, second, and third sub-routes of the transport route in the opposite direction.

15. The transport system according to claim 14, wherein one of the third sub-routes is coupled to a third node of the first nodes and a fourth node of the second nodes, the start and target nodes are disposed on the first and second sub-routes, respectively, the third and fourth nodes are disposed between the start and target nodes, and the one transport vehicle moves along the one of the third sub-routes during moving from the start node to the target node when the one of the third sub-routes is a shortest route between the start and target routes among the first, second, third sub-routes.

16. The transport system according to claim 15, wherein the one transport vehicle does not move along another one of the third sub-routes other than the one of the third sub-routes.

17. The transport system according to claim 7, further comprising:
a job assigning part calculating the transport time to be taken when the transport vehicles in the transport route perform the at least one job order, and creating job assignment information to assign each job order to a corresponding one of the transport vehicles having a minimum transport time according to the at least one job order.

18. The transport system according to claim 17, further comprising:
a route searching part receiving the job assignment information from the job assigning part, creating the route search information by searching the optimum route having the minimum transport time to be taken when the one transport vehicle assigned with the job order travels from the starting node to the target node in the opposite directions of the transport route.

19. The transport system according to claim 18, wherein the route searching part updates the route search information by searching routes in real time when the other one of the transport vehicles travels between the start node and the target node according to another job order.

20. The transport system according to claim 7, wherein the transport vehicles moves between adjacent nodes in the opposite directions.

21. A transport method of transporting an article from a start node to a target node along a transport route having nodes including the start and target nodes, comprising:
moving transport vehicles along the transport route in one of opposite directions of the transport route;
receiving at least one job order from an external host to move the article disposed in the start node to the target node;
creating job assignment information to assign the at least one job order to a corresponding one of the transport vehicles having a minimum transport time to be taken when the one transport vehicle perform the at least one job order;
creating route search information by searching an optimum route having the minimum transport time to be taken when the one transport vehicle travels from the starting node to the target nodes in the opposite directions of the transport route; and
controlling the one transport vehicle according to the job assignment information and the route search information.
